(19) United States
(12) Patent Application Publication
(10) Pub. No.: US 2002/0088818 A1
(43) Pub. Date: Jul. 11, 2002

(54) Single cigarette vending machine

(76) Inventor: Dalphine A. Smith Atkinson, Garner, NC (US)

Correspondence Address: DALPHINE A. SMITH, 102 STEFI CT., GARNER, NC, 27529, US

(21) Appl. No.: 09/950,106

(22) Filed: Sep. 10, 2001

Related U.S. Application Data
(60) Provisional application No. 60/232,232, filed on Sep. 12, 2000.

(51) Int. Cl. B65H 3/44; G07F 11/00

(52) U.S. Cl. 221/131

(57) ABSTRACT

A vending machine that includes a number of compartments for positioning a number of individual cigarettes of a particular brand and which is in connection with a vending mechanism which is triggerable by the user once the required number of coins or payment is inserted into a payment verification device. Once the payment verification device has been triggered the user can then operate one of the vending mechanisms to vend a single cigarette of the desired type from the compartment holding that particular brand.

### TECHNICAL FIELD

The present invention relates to vending machines and more particularly to a single cigarette vending machine that is adapted to vend a single cigarette at a time from a number of displayed vending sections wherein the cigarettes are held in a stacked order and wherein a single cigarette is vended for each insertion of the proper coins or tokens.

### BACKGROUND OF INVENTION

It is often desirable for individuals who do not wish to purchase an entire pack of cigarettes to purchase one cigarette at a time. It would be desirable, therefore, to have a vending machine which could be used to vend a single cigarette at a time to allow those individuals who wish to cut back on their cigarette usage to purchase a single cigarette instead of purchasing an entire pack.

### SUMMARY OF INVENTION

It is thus an object of the invention to provide a single cigarette vending machine that is adapted to vend a single cigarette at a time from a number of displayed vending sections wherein the cigarettes are held in a stacked order and wherein a single cigarette is vended for each insertion of the proper coins or tokens.

Accordingly, a single cigarette vending machine is provided. The single cigarette vending machine is adapted to vend a single cigarette at a time from a number of displayed vending sections wherein the cigarettes are held in a stacked order and wherein a single cigarette is vended for each insertion of the proper coins or tokens.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows a front plan view of an exemplary embodiment of the single cigarette vending machine of the present invention.

FIG. 2 shows a side plan view of an exemplary embodiment of the single cigarette vending machine of the present invention.

### EXEMPLARY EMBODIMENTS

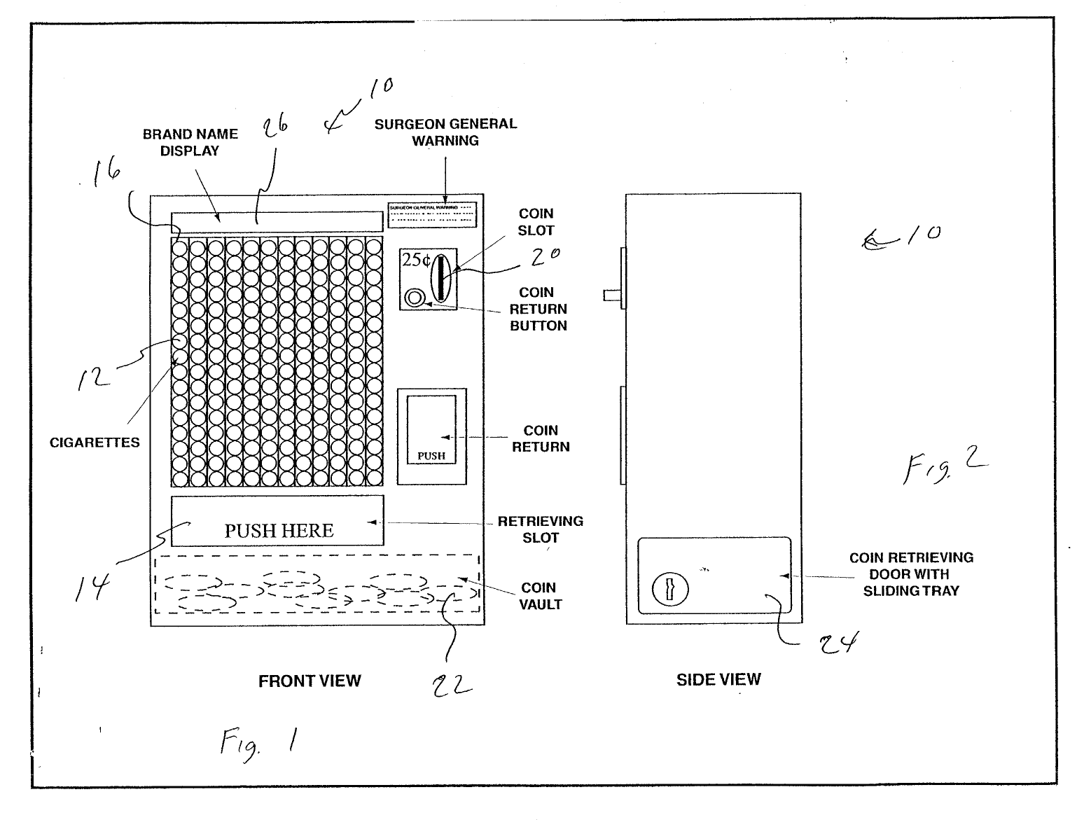

FIGS. 1 and 2 show various aspects of an exemplary embodiment of the single cigarette vending machine of the present invention generally designated 10. Single cigarette vending machine 10 is adapted to vend a single cigarette 12 out into a vending area 14 from one of a number of vertically oriented cigarette storage slots 16 once the user deposits a coin into a payment receiving device 20 such as a coin slot receiving member. Although a coin slot receiving member 20 is used in this embodiment other types of payment verification devices can be used without departing from the spirit and intent of the present invention.

The single cigarette vending machine 10 includes a coin vault 22 for storing coins used as payment and a coin retrieving door 24 for accessing coin vault 22 and removing the coins on a periodic basis.

It can be seen from the preceding description that a single cigarette vending machine has been provided.

It is noted that the embodiment of the single cigarette vending machine described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

### Features and Benefits

Features

Durable Metal Materials.

Steel & Glass Outer Case.

Brand Name Display.

Surgeon General's Warning.

Gravity-Feed Slotted Racks.

Collection Trough.

Coin Management System.

Coin Vault.

Motorized Dispensing System.

Retrieval Compartment.

Mounting Bracket.

Functionally Effective Design.

Benefits:

Quick And Easy To Install.

Simple To Use.

Dispenses One Cigarette At A Time.

Cost-Effective For Consumers.

Profitable For Rent, Lease, Or Purchase.

Offers Alternative To Full Pack Purchase.

Convenient For Consumers That Have Forgotten Their Cigarettes Or Who Seldom Smoke.

Ideally Suited For Bars & Restaurants.

Beneficial For Most Commercial Establishments.

Aesthetically Pleasing Design.

Typically Used In Pairs (One Menthol-One Regular).

### Need

Clearly, by offering a viable alternative to full pack purchase, this device will allow cost-conscience consumers to purchase one cigarette at a time. Convenient and easy to use, The Single Cigarette Vending Machine will introduce smokers and vending machine operators to an alternative method of dispensing cigarettes.

### Consumer Base

The potential demand for this product is considerable. For most of the last three decades, cigarette usage has dropped. Recently a resurgence of usage has been documented, especially among younger age groups. A recent survey showed that over 26.5% U.S. National Center for Health Statistics, Health United States—1993 of Americans were cigarette smokers.

While all of these smokers would not necessarily benefit from or become immediate users of this device, these statistics are instructive and indicative of a large and burgeoning market.

### PRODUCT COMPONENT CLARIFICATION

| | | |
|---|---|---|
| INVENTION NAME: | The SINGLE CIGARETTE | DATE: 02/29/00 |
| | VENDING MACHINE | |
| INVENTOR'S NAME: | Dalphine A. Smith | |
| UCS NUMBER: | UCSNC-4455-RD | |

The Single Cigarette Vending Machine is a vending machine that will dispense a single cigarette instead of a pack. The Single Cigarette Vending Machine will be compact so that it can be easily placed on a bar.

Drawing No. 1

1. Standard Surgeon Generals warning found on all packs of cigarette currently sold in the United States.

2. Plastic compartments that hold the label of the brand of cigarette.

3. Slot for inserting a quarter to purchase an individual cigarette.

4. Individual compartment for the cigarettes to be placed in.

5. Clear plastic over the face of the vending machine. This will allow the user to see if the cigarette brand of his/her choice is available.

6. Coin return.

7. Plastic door over the compartment that the individual cigarette falls into after purchase. The door will be hinged at the top and when the user pushes, it will swing open.

8. Push button or pull rod that the user either pushes or pulls to make their selection. The button will be available if the Cigarette machine is electrical and the pull rod will be the same design used in older style cigarette machines.

9. Coin box located in the interior of the vending machine, which is detailed in drawing No. 3.

Drawing No. 2

10. Front of the Single Cigarette Vending Machine.

11. Pull rod or push switch located on the front of the vending machine.

12. A door located at the bottom of an individual cigarette holder compartment. The door will swing open and allow the cigarette to fall into the lower compartment so that the user, after purchase, can obtain his cigarette.

13. Compartment where the user will retrieve his/her cigarette.

14. Swing door located on the front of the vending machine.

Drawing No. 3

[image]

15. Metal coin box that the coins are drop into after purchase.

16. Hinges located on the door to the coin box. This will allow the door to open.

17. Metal door located on the coin box.

18. Keyhole and lock so that the coin box can be locked and only allow the owner to open.

19. Bottom of the Single Cigarette Vending Machine. The sides are slotted so that the coin box can be slid in and out of the machine.

20. Rails or rollers mounted on the bottom edges of the coin box to slide on the slots located on the bottom of the vending machine.

Drawing No. 4

21. Individual cigarette compartments with a clear plastic cover.

22. Pull rods or push buttons located at the bottom of the cigarette holders to allow the user to select his/her brand of cigarette. If the machine contains electrical components push buttons will be used, if the vending machine is not electrical, pull rods will be used.

My staff and I have illustrated the 4 key factors, which you identified in your engagement letter and Disclosure Document. The illustration of these key points will make the most favorable impression on the manufacturer who may consider your product for licensing (production, marketing, royalty payment, etc.) or a direct buy out.

[image]

[image]

1. The Single Cigarette Vending Machine is a vending machine that will dispense a single individually wrapped cigarette when activated by the insertion of specified coins. This will prevent an individual from smoking as many cigarettes due to the limited, conservative availability. Thus decreasing the risks associated with heart disease.

2. The machine will display the standard Surgeon General warning as found on all packs of cigarette currently sold in the United States. They must only be sold be merchants where minors are not permitted.
